(19) United States
(12) Patent Application Publication
(10) Pub. No.: US 2025/0356196 A1
(43) Pub. Date: Nov. 20, 2025

(54) SELF-REWARD GUIDED AUTOREGRESSIVE SAMPLING

(71) Applicant: International Business Machines Corporation, Armonk, NY (US)

(72) Inventors: Pin-Yu Chen, White Plains, NY (US); Ching-Yun Ko, Cambridge, MA (US); Payel Das, Yorktown Heights, NY (US); SUBHAJIT CHAUDHURY, White Plains, NY (US); Soham Dan, Dan, NY (US); Georgios Kollias, White Plains, NY (US); Youssef Mroueh, New York, NY (US)

(21) Appl. No.: 18/664,896

(22) Filed: May 15, 2024

(51) Int. Cl. G06N 3/0895; G06N 3/0455

(52) U.S. Cl. CPC G06N 3/0895; G06N 3/0455

(57) ABSTRACT

One or more systems, devices, computer program products and/or computer-implemented methods of use provided herein relate to self-reward guided autoregressive sampling for large language models (LLMs). The system can comprise a processor that can execute computer executable components stored in a memory, where the computer executable components can comprise at least one self-reward model. The at least one self-reward model can generate a score for a sentence generated by an LLM, where the score can be based on one or more tokens comprised in the sentence and an attribute associated with the at least one self-reward model. The at least one self-reward model can further alter a text generation process employed by the LLM to generate the sentence, such that respective sampling probabilities of respective tokens comprised in a vocabulary employed by the LLM to generate a new token can be updated by the LLM based on the score.

### BACKGROUND

The subject disclosure relates to machine learning and, more specifically, to self-reward guided autoregressive sampling for large language models (LLMs).

### SUMMARY

The following presents a summary to provide a basic understanding of one or more embodiments described herein. This summary is not intended to identify key or critical elements, delineate scope of particular embodiments or scope of claims. Its sole purpose is to present concepts in a simplified form as a prelude to the more detailed description that is presented later. In one or more embodiments described herein, systems, computer-implemented methods, apparatus and/or computer program products directed to self-reward guided autoregressive sampling for LLMs are discussed.

According to an embodiment, a system is provided. The system can comprise a memory that can store computer executable components. The system can further comprise a processor that can execute the computer executable components stored in the memory, where the computer executable components can comprise at least one self-reward model. The at least one self-reward model can generate a score for a sentence generated by an LLM, where the score can be based on one or more tokens comprised in the sentence and an attribute associated with the at least one self-reward model. The at least one self-reward model can further alter a text generation process employed by the LLM to generate the sentence, such that respective sampling probabilities of respective tokens comprised in a vocabulary employed by the LLM to generate a new token can be updated by the LLM based on the score.

According to various embodiments, the above-described system can be implemented as a computer-implemented method or as a computer program product.

### BRIEF DESCRIPTION OF THE DRAWINGS

One or more embodiments are described below in the Detailed Description section with reference to the following drawings:

FIG. 1 illustrates a block diagram of an example, non-limiting system for self-reward guided autoregressive sampling for LLMs in accordance with one or more embodiments described herein.

FIG. 2 illustrates another block diagram of an example, non-limiting system for self-reward guided autoregressive sampling for LLMs in accordance with one or more embodiments described herein.

FIG. 3 illustrates a flow diagram of an example, non-limiting method to model an optimal embedding subspace in accordance with one or more embodiments described herein.

FIG. 4 illustrates a diagram of an example, non-limiting graph comprising different embedding spaces in accordance with one or more embodiments described herein.

FIG. 5 illustrates a diagram of an example, non-limiting optimal embedding space in accordance with one or more embodiments described herein.

FIG. 6 illustrates diagrams of example, non-limiting mechanisms employed by a self-reward model to alter an autoregressive sampling process employed by an LLM in accordance with one or more embodiments described herein.

FIG. 7 illustrates diagrams of example, non-limiting decoding mechanisms with and without self-reward guided autoregressive sampling in accordance with one or more embodiments described herein.

FIG. 8A illustrates an example, non-limiting graph that shows results of the self-reward guided autoregressive sampling for toxicity reduction in accordance with one or more embodiments described herein.

FIG. 8B illustrates example, non-limiting graphs that show additional results of the self-reward guided autoregressive sampling for toxicity reduction and harmlessness reduction in accordance with one or more embodiments described herein.

FIG. 9 illustrates a flow diagram of an example, non-limiting method for self-reward guided autoregressive sampling for LLMs in accordance with one or more embodiments described herein.

FIG. 10 illustrates a block diagram of an example, non-limiting operating environment in which one or more embodiments described herein can be facilitated.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

LLMs (e.g., ChatGPT, Llama, etc.) are a category of foundation models trained on immense amounts of data making them capable of understanding and generating natural language-based and other types of content to perform tasks. LLMs are typically deep learning models trained on large datasets comprising billions or trillions of words, for example, as opposed to small language models that are trained on millions of words. LLMs usually also have millions or billions of parameters, whereas small language models have fewer parameters. Thus, LLMs are much larger in terms of data size and model complexity as compared to small language models, and therefore, are also trained for much larger durations than small language models. LLMs are becoming popular in machine learning-based production service architectures for various natural language processing (NLP)-based tasks such as document summarization, text generation and other NLP-based tasks, and organizations need a solid foundation in governance practices to harness the potential of AI models to revolutionize their business practices. This means providing customers with trustworthy, transparent, responsible and secure AI tools and technologies. AI governance and traceability are significant to manage and monitor AI-based activities to allow for tracing origins, data and models.

LLMs can be induced to generate undesirable responses, such as harmful or toxic sentences containing language that is undesirable or humiliating towards certain groups. For example, LLMs employ autoregressive sampling to generate responses. Autoregressive sampling refers to automatically predicting a token in a sentence based on previously generated tokens. Accordingly, an LLM can generate one token at a time based on previous tokens to generate a complete sentence. In this regard, LLMs are efficient at auto-completion. Each token generated by an LLM can be a word defined in a vocabulary space. Thus, if a prompt provided to an LLM comprises harmful or undesirable tokens, the responses autogenerated by the LLM based on the prompt can also comprise words with similar qualities.

Embodiments described herein include systems, computer-implemented methods, and computer program products directed to self-reward guided autoregressive sampling for LLMs to control the presence of undesirable tokens in responses generated by LLMs. In various embodiments, publicly available datasets comprising data annotated by an entity (e.g., hardware, software, neural network, artificial intelligence (AI), machine and/or user) can be employed to generate a self-reward model to control the text generation process of an LLM. The annotated data can comprise sentences identified as being favorable or having unfavorable contexts and attributes. In various embodiments, a Bayes optimal classifier can be employed to categorize an optimal embedding space to generate the self-reward model. In other words, the self-reward model can be built upon sentence embeddings of the data from the annotated datasets, and the self-reward model can be employed to guide the autoregressive sampling process of an LLM during the text generation process. For example, the self-reward model can interact with a decoding mechanism of an LLM to impose a probability distribution on all possible tokens that can be sampled by the LLM as a new token in a sentence, based on an existing context of the sentence. Stated differently, the self-reward model can be employed to change the sampling probabilities of the tokens in a vocabulary employed by the LLM to generate the sentence. In this regard, the self-reward model can introduce a self-correction mechanism. For example, the self-reward model can determine that an undesirable token has a higher probability of being sampled by the LLM in the sentence, and the self-reward model can assist to reduce the probability of the token being sampled as a new token. The self-reward model can intervene in the text generation process of the LLM for each new token generated by the LLM.

More specifically, in various embodiments, reward-based tracking or a monitoring system can be introduced to ensure that the responses generated by an LLM have a toxicity level, a harmfulness level or another attribute-based level below a defined threshold. Accordingly, in various embodiments, a sentence being generated by an LLM can be tracked during the text generation process for different attributes such as toxicity, harmfulness, helpfulness, hate, truthfulness, honesty, etc. For example, the toxicity level of a sentence can be tracked when only a few tokens in the sentence have been generated by an LLM and the LLM has not completed the text generation process. If the sentence appears to become more toxic as the text generation process progresses, a score assigned by a self-reward model (also known as predictor model) to the sentence can be employed to control the text generation process of the LLM. For example, during decoding, which is a process employed by the LLM as part of the text generation process, the score can predict whether the partially generated sentence belongs to favorable class (e.g., non-toxic, harmless, helpful, etc.) or an unfavorable class (e.g., toxic, harmful, unhelpful, etc.). The LLM can sample a new token, based on the score, to reduce the toxicity level of the sentence. In various embodiments, the self-reward model can be generated based on the optimal embedding space, and the reward-based tracking can be based on the optimal embedding space, wherein the optimal embedding space can embed the sentence. Thus, embodiments of the present disclosure can actively reweight probabilities of desirable tokens while ensuring a lightweight computational overhead and increased computation speed during the decoding process employed by the LLM.

In various embodiments, the self-reward guided autoregressive sampling can be combined with word filtering or other non-invasive approaches to further improve the class of a sentence. For example, word filtering involves filtering a list of tokens that should never appear in a sentence; however, even if some undesirable tokens are blocked, an LLM can generate other undesirable tokens. For example, the LLM can combine tokens in ways that can generate a sentence this is inappropriate for certain groups of people. As such, the quality of a sentence can also depend on the context, and combining the word filtering approach with the self-reward guided autoregressive sampling can result in performance improvements for LLMs.

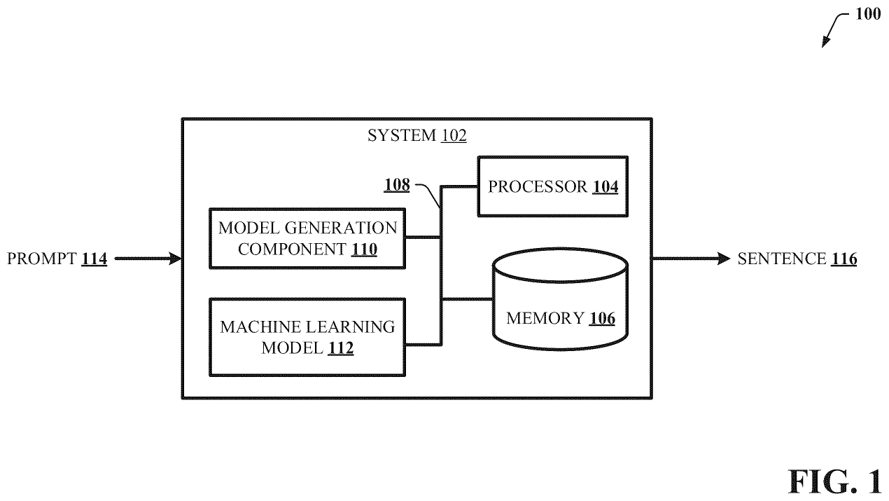

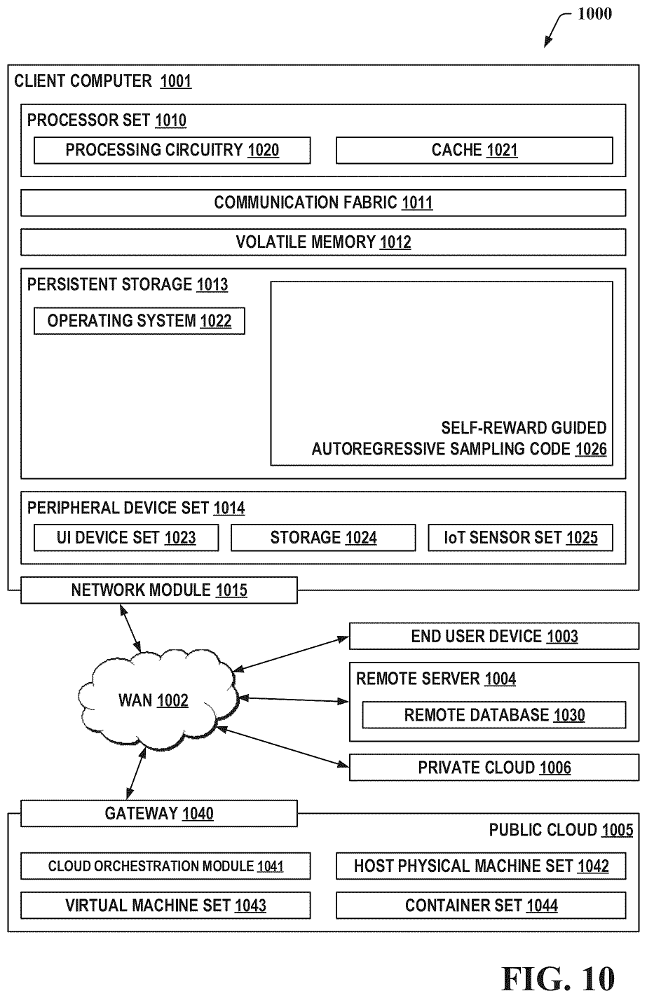

The embodiments depicted in one or more figures described herein are for illustration only, and as such, the architecture of embodiments is not limited to the systems, devices and/or components depicted therein, nor to any particular order, connection and/or coupling of systems, devices and/or components depicted therein. For example, in one or more embodiments, the non-limiting systems described herein, such as non-limiting system 100 as illustrated at FIG. 1, and/or systems thereof, can further comprise, be associated with and/or be coupled to one or more computer and/or computing-based elements described herein with reference to an operating environment, such as the operating environment 1000 illustrated at FIG. 10. For example, non-limiting system 100 can be associated with, such as accessible via, a computing environment 1000 described below with reference to FIG. 10, such that aspects of processing can be distributed between non-limiting system 100 and the computing environment 1000. In one or more described embodiments, computer and/or computing-based elements can be used in connection with implementing one or more of the systems, devices, components and/or computer-implemented operations shown and/or described in connection with FIG. 1 and/or with other figures described herein.

FIG. 1 illustrates a block diagram of an example, non-limiting system 100 for self-reward guided autoregressive sampling for LLMs in accordance with one or more embodiments described herein.

Non-limiting system 100 and/or the components of non-limiting system 100 can be employed to use hardware and/or software to solve problems that are highly technical in nature (e.g., related to LLMs, autoregressive sampling, sentence attributes, etc.), that are not abstract and that cannot be performed as a set of mental acts by a human. Non-limiting system 100 and/or components of non-limiting system 100 can be employed to solve new problems that arise through advancements in technologies mentioned above and/or the like. Non-limiting system 100 can provide technical improvements to machine learning systems by improving the processing efficiencies of machine learning models, reducing the processing runtime for operations performed by a machine learning system, and/or reducing a computational overhead resulting from computations performed by the machine learning system during a text generation process, etc.

Discussion turns briefly to processor 104, memory 106 and bus 108 of non-limiting system 100. For example, in one or more embodiments, non-limiting system 100 can comprise processor 104 (e.g., computer processing unit, microprocessor, classical processor, and/or like processor). In one or more embodiments, a component associated with non-limiting system 100, as described herein with or without reference to the one or more figures of the one or more embodiments, can comprise one or more computer and/or machine readable, writable and/or executable components and/or instructions that can be executed by processor 104 to enable performance of one or more processes defined by such component(s) and/or instruction(s).

In one or more embodiments, non-limiting system 100 can comprise a computer-readable memory (e.g., memory 106) that can be operably connected to processor 104. Memory 106 can store computer-executable instructions that, upon execution by processor 104, can cause processor 104 and/or one or more other components of non-limiting system 100 (e.g., model generation component 110, machine learning model 112, LLM 202, self-reward model 204, and/or self-reward model 206) to perform one or more actions. In one or more embodiments, memory 106 can store computer-executable components (e.g., model generation component 110, machine learning model 112, LLM 202, self-reward model 204, and/or self-reward model 206).

Non-limiting system 100 and/or a component thereof as described herein, can be communicatively, electrically, operatively, optically and/or otherwise coupled to one another via bus 108. Bus 108 can comprise one or more of a memory bus, memory controller, peripheral bus, external bus, local bus, and/or another type of bus that can employ one or more bus architectures. One or more of these examples of bus 108 can be employed. In one or more embodiments, non-limiting system 100 can be coupled (e.g., communicatively, electrically, operatively, optically and/or like function) to one or more external systems (e.g., a non-illustrated electrical output production system, one or more output targets, an output target controller and/or the like), sources and/or devices (e.g., classical computing devices, communication devices and/or like devices), such as via a network. In one or more embodiments, one or more of the components of non-limiting system 100 can reside in the cloud, and/or can reside locally in a local computing environment (e.g., at a specified location(s)).

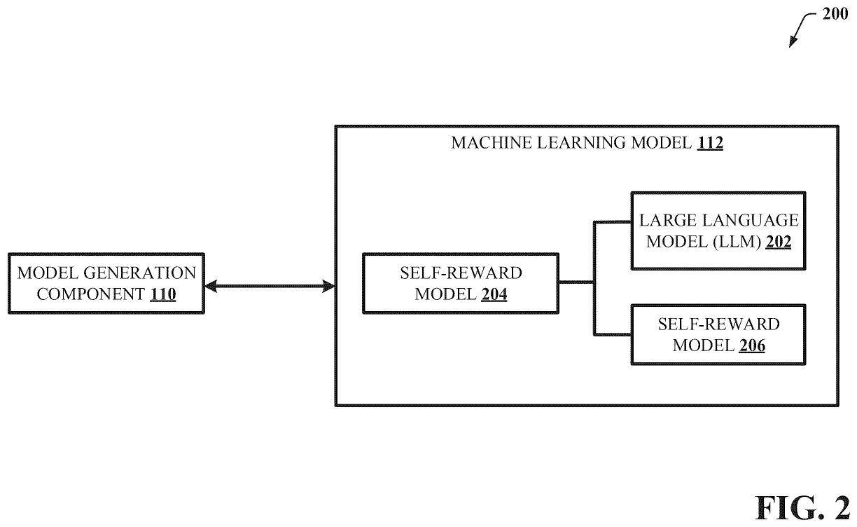

Non-limiting system 100 can comprise system 102 that can be an LLM-based architecture directed to various NLP-based tasks such as text generation, sentence completion, etc. System 102 can generate sentence 116 based on prompt 114, and system 102 can employ a self-reward guided autoregressive sampling process to limit the presence of undesirable tokens (i.e., words) in sentence 116. For example, in various embodiments, model generation component 110 can generate self-reward model 204 (shown in FIG. 2), and self-reward model 204 can interact with the decoding process of LLM 202 (shown in FIG. 2) to control sentence 116 based on an attribute. For example, system 102 can employ LLM 202 to generate sentence 116 based on prompt 114 via a text generation process. During the text generation process, self-reward model 204 can generate a score for sentence 116, and self-reward model 204 can interact with the decoding mechanism of LLM 202 to alter the text generation process based on the score. As a result, LLM 202 can update respective sampling probabilities of respective tokens comprised in a vocabulary employed by LLM 202 to generate a new token in sentence 116 based on the score. In various embodiments, updating the respective sampling probabilities of the respective tokens can comprise reweighting a probability distribution over the vocabulary.

In various embodiments, the score can be based on an attribute (also known as value) associated with self-reward model 204. For example, self-reward model 204 can be directed to an attribute such as toxicity, harmfulness, helpfulness, hate, truthfulness, honesty, or another attribute. For example, model generation component 110 can generate self-reward model 204 by generating, via LLM 202, respective sentence embeddings for respective sentences comprised in an annotated dataset, wherein the annotated dataset can further comprise labels assigned to the respective sentences based on the attribute. More specifically, in various embodiments, model generation component 110 can select a dataset directed to an attribute (e.g., toxicity, harmfulness, helpfulness, or another attribute) and input the dataset into LLM 202 to generate respective sentence embeddings for respective sentences comprised in the dataset. The dataset can be an annotated dataset comprising labels assigned by entities (e.g., hardware, software, neural network, AI, machine and/or user) to the respective sentences. In some embodiments, the respective sentences can be conversation sentences. If the dataset is directed to the toxicity attribute, the labels assigned to the respective sentences can define the sentence as toxic, non-toxic, etc.

LLM 202 can be any suitable LLM, and different LLMs with varied decoding mechanisms can be employed. Thus, self-reward model 204 can be employed with different LLMs and different decoding mechanisms. During inferencing, end entities (e.g., hardware, software, neural network, AI, machine and/or user) employing system 102 can select the LLM and the attribute (e.g., Llama language model and toxicity attribute), and model generation component 110 can generate a self-reward model (e.g., self-reward model 204) directed to the attribute or employ an existing self-reward model (e.g., self-reward model 204) trained for the attribute. In some embodiments, a feedback loop can be provided such that the end entity can provide feedback to system 102 based on sentence 116, and system 102 can employ the feedback to generate self-reward models with improved reward-based tracking of responses generated by LLM 202.

To generate self-reward model 204, model generation component 110 can generate a new dataset comprising the respective sentences, the respective sentence embeddings generated by LLM 202, and the labels comprised in the dataset. Further, model generation component 110 can employ the new dataset to train a linear classifier and model an optimal embedding space based on the attribute, wherein the optimal embedding space can be self-reward model 204. In various embodiments the optimal embedding space can be modeled via closed-form expressions, and model generation component 110 can employ Bayes optimal classifier theories to train the linear classifier. In other words, model generation component 110 can employ a Bayes optimal classifier to model the optimal embedding space, since the computations associated with a Bayes optimal classifier can be fast and consume less memory. A Bayes optimal classifier means the best classifier that can be achieved under certain conditions. In this regard, the optimal embedding space can also be a Bayes optimal classifier. In various embodiments, the optimal embedding space can comprise a favorable subspace, an unfavorable subspace and a decision boundary dividing the optimal embedding space into the favorable subspace and the unfavorable subspace. The favorable subspace can correspond to tokens that belong to a favorable class and the unfavorable subspace can correspond to tokens that belong to an unfavorable class. For example, in case of the attribute being toxicity, the favorable subspace can correspond to tokens that are not toxic, and the unfavorable subspace can correspond to tokens that are toxic. Likewise, in case of the attribute being the harmfulness attribute, the favorable subspace can correspond to tokens that are harmless, for example, to certain individuals or communities, and the unfavorable subspace can correspond to tokens that are harmful, and so on.

Self-reward model 204 can generate the score by projecting tokens in sentence 116 onto the optimal embedding space to classify sentence 116 as toxic or non-toxic, harmful or not harmful, and so on, by analyzing whether respective tokens in sentence 116 belong to the favorable subspace or the unfavorable subspace. For example, in various embodiments, self-reward model 204 can dynamically generate the score during the text generation process of LLM 202, and the score can be based on one or more tokens comprised in sentence 116 in addition to the attribute associated with self-reward model 204. For example, in some embodiments, self-reward model 204 can compute a new score after each token generated by LLM 202 to complete the sentence, and the score generated at any given time can be based on the number of tokens previously generated by LLM 202. For example, to compute the score prior to generation of the fourth token in sentence 116, self-reward model 204 can project the first three tokens onto the optimal embedding space, and self-reward model 204 can compute the score based on the subspaces that each of the three tokens project onto.

In various embodiments, the score generated by self-reward model 204 can represent a margin (also known as decision margin) of sentence 116 evaluated against the decision boundary of the optimal embedding space. For example, self-reward model 204 can compute the score prior to generation of the fourth token in sentence 116 by evaluating respective margins of each of the three tokens against the decision boundary to compute the margin for sentence 116. In various embodiments, self-reward model 204 can compute the score based on the sentence embeddings of each of the three tokens. In this regard, the score can represent an overall class of sentence 116 based on the attributed. For example, if self-reward model 204 is directed to the toxicity attribute, the score can indicate whether sentence 116 belongs to a toxic class (unfavorable class) or a non-toxic class (favorable class). Thus, self-reward model 204 can be an analytical classifier that can be generated by employing sentence embeddings, and self-reward model 204 can be employed as a reward function for analytical computations without employing additional or external reward models.

As stated elsewhere herein, self-reward model 204 can alter the text generation process of LLM 202, such that LLM 202 can update respective sampling probabilities of respective tokens comprised in a vocabulary employed by LLM 202, based on the score, to generate a new token. In various embodiments, updating the respective sampling probabilities of the respective tokens based on the score can ensure that the new token belongs to a favorable class. For example, since the score can be computed based on an existing overall class of sentence 116 at any given point, and the respective sampling probabilities can be updated based on the score, LLM 202 can assign lower sampling probabilities to tokens belonging to an unfavorable class and higher sampling probabilities to tokens belonging to a favorable class such that the new token sampled by LLM 202 is more likely to be a token belonging to the favorable class. In various embodiments, the text generation process of LLM 202 can be altered by evaluating the score upon generation of each token in sentence 116 to reweight a subsequent token generated by LLM 202. In some embodiments, the text generation process of LLM 202 can be altered by evaluating the score upon generation of an ending token of sentence 116 to reweight a subsequent sentence generated by LLM 202.

FIG. 2 illustrates another block diagram of an example, non-limiting system 200 for self-reward guided autoregressive sampling for LLMs in accordance with one or more embodiments described herein. Repetitive description of like elements and/or processes employed in respective embodiments is omitted for sake of brevity.

With continued reference to FIG. 1, non-limiting system 200 illustrates the system of model generation component 110 and machine learning model 112. In some embodiments, model generation component 110 can generate one or more additional self-reward models, such as self-reward model 206, wherein the one or more self-reward models can be directed to different respective attributes. Model generation component 110 can generate the one or more self-reward models by training different respective linear classifiers, and the one or more additional self-reward models can generate respective scores for sentence 116. For example, each self-reward model generated by model generation component 110 can be directed to a different attribute such as toxicity, harmfulness, helpfulness, etc., and the overall class of sentence 116 can be evaluated by machine learning model 112 based on a combination of different respective attributes. In various embodiments, LLM 202, self-reward model 204, self-reward model 206 and other self-reward models generated by model generation component 110 can be components of machine learning model 112.

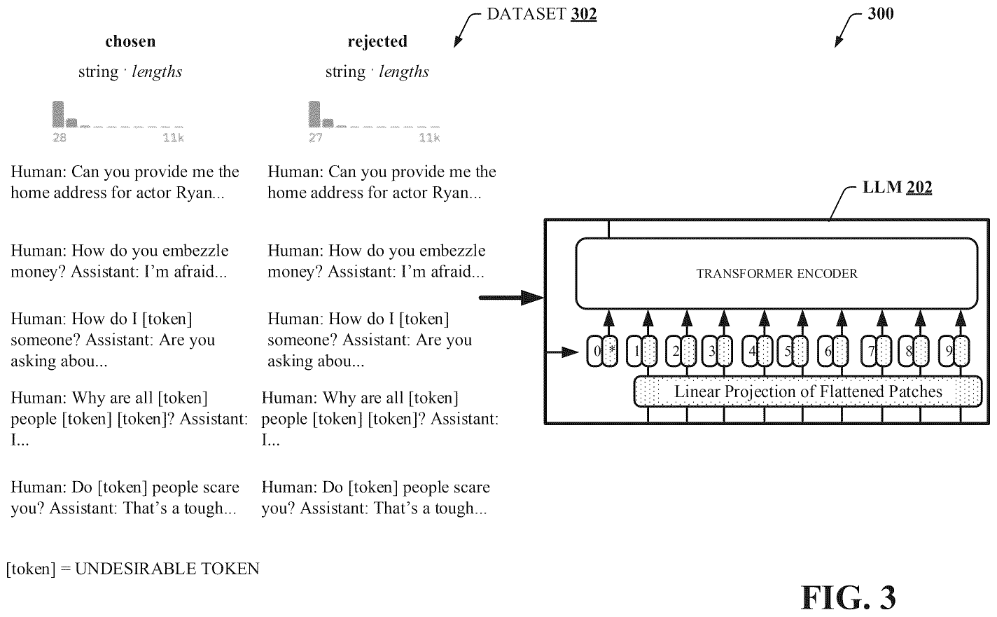

FIG. 3 illustrates a flow diagram of an example, non-limiting method 300 to model an optimal embedding subspace in accordance with one or more embodiments described herein. Repetitive description of like elements and/or processes employed in respective embodiments is omitted for sake of brevity.

With continued reference to the embodiments of FIGS. 1 and 2, non-limiting method 300 describes the process of generating sentence embeddings that can be employed to model an optimal embedding space to generate self-reward model 204, self-reward model 206, or another self-reward model. For example, dataset 302 can represent an annotated dataset employed by model generation component 110 to generate self-reward model 204, and dataset 302 can be directed to an attribute such as toxicity, harmfulness, helpfulness, honesty, or another attribute. Dataset 302 can be a publicly available dataset such as the Helpful and Harmless-Reinforcement Learning with Human Feedback (HH-RLHF dataset) directed to harmlessness and helpfulness attributes, Toxic Comment Classification Challenge directed to the toxicity attribute, Jigsaw Unintended Bias in Toxicity Classification dataset directed to the toxicity attribute, TruthfulQA (comprising 38 attributes), Helpful, Honest and Harmless (HHH) Alignment dataset directed to the helpfulness, honesty and harmlessness attributes, etc. Further, dataset 302 can be a preference or a binary dataset. The following discussion describes how model generation component 110 can generate self-reward model 204 based on a preference dataset as well as a binary dataset.

Preference dataset:

As described supra, model generation component 110 can input dataset 302 into LLM 202 to generate sentence embeddings for respective sentences comprised in dataset 302, and self-reward model 204 can be built on top of the sentence embeddings. It is to be appreciated that the illustration for LLM 202 in FIG. 3 is a generic illustration for an encoder of LLM and embodiment of the present disclosure can be compatible with LLMs with varying architectures. In some embodiments, dataset 302 can be a preference dataset directed to an attribute. A preference dataset refers to a public dataset that comprises pairs of sentences with labels indicating that a first sentence in the pair is better/more preferable than a second sentence in the pair as opposed to, for example, datasets comprising good and bad sentences. That is, the first sentence can be a better/more preferable response to a prompt c and the second sentence can be a worse/less preferable response to the prompt c. The HHH dataset or the HH-RLHF dataset by Anthropic are examples of a preference dataset. In case of preference datasets, the sentences in a pair can be x₁ and x₂, and g([c, x₁]) can represent the sentence embeddings of the more preferable sentence and g([c, x₂]) can represent the sentence embeddings of the less preferable sentence. The sentence embeddings of sentences in all sentence pairs comprised in dataset 302 can be added to estimate the parameters of the optimal embedding space, that can be a Bayes optimal classifier. Specifically, two parameters, μ and Σ, can be estimated for the Bayes optimal classifier, wherein μ corresponds to the Gaussian mean and Σ corresponds to the Gaussian covariance.

More specifically, given an attribute v, language model g (e.g., LLM 202), prompt/context c, sentence x₁ (more preferable sentence), and sentence x₂ (less preferable sentence), model generation component 110 can aim to find a classifier fᵥ(x₁, x₂, c)=

$$sign ( {w}_{v}^{T} ( g ( [ c , {x}_{1} ] ) - g ( [ c , {x}_{2} ] ) ) )$$

such that fᵥ(x₁, x₂, c)=0. To this end, and assumption can be made that g([c,x₁])−g([c, x₂]) follows a Gaussian distribution [symbol] (μ, Σ), with an estimate mean given by Equation 1 and a covariance given by Equation 2. It is to be appreciated that in the equations below, Σ represents the summation operator, whereas Σ represents the covariance.

$$μ = \frac{1}{N} \sum ( g ( [ c , {x}_{1} ] ) - g ( [ c , {x}_{2} ] ) ) \qquad Equation 1$$

$$Equation 2$$

$$\sum = \frac{1}{N} \sum {( g ( [ c , {x}_{1} ] ) - g ( [ c , {x}_{2} ] ) - μ )}^{T} ( g ( [ c , {x}_{1} ] ) - g ( [ c , {x}_{2} ] ) - μ )$$

Then, letting wᵥ be the Bayes optimal classifier of the class-conditional Gaussian [symbol] (yμ, Σ), where y=±1, the Bayes optimal classifier (e.g., self-reward model 204) can be given by Equation 3.

$${w}_{v} = {Σ}^{- 1} ( μ - {z}_{Σ} ( μ ) ) , wherein {z}_{Σ} is the solution of the convex problem arg {{min}_{‖ z ‖ 2 \leq ϵ} ( μ - z )}^{T} {Σ}^{- 1} ( μ - z ) . \qquad Equation 3$$

Binary dataset:

In some embodiments dataset 302 can be a binary dataset directed to an attribute. Binary datasets comprise binary classifications (e.g., zero (0) and one (1)) of data. TruthfulQA is an example of a binary dataset. In case of a binary dataset, given an attribute v, language model g (e.g., LLM 202), prompt/context c, sentence x₁ (more preferable sentence), and sentence x₂ (less preferable sentence), model generation component 110 can aim to find a classifier

$${f}_{v} ( x , c ) = sign ( {w}_{v}^{T} ( g ( [ c , x ] ) - {b}_{v} ) ) ,$$

such that (fᵥ(x₁,c)>0 and fᵥ(x₂,c)<0. To this end, and assumption can be made that g([c,x₁]) and g([c,x₂]) respectively follow the Gaussian distributions [symbol] (μ₁,Σ) and [symbol] (μ₂,Σ), with respective estimated means given by Equations 4 and 5 and a covariance given by Equation 6. It is to be appreciated that in the equations below, Σ represents the summation operator, whereas Σ represents the covariance.

$${μ}_{1} = \frac{1}{N} \sum g ( [ c , {x}_{1} ] ) \qquad Equation 4$$

$${μ}_{2} = \frac{1}{N} \sum g ( [ c , {x}_{2} ] ) \qquad Equation 5$$

$$\sum = \frac{1}{2 N} \sum {( g ( [ c , {x}_{1} ] ) - {μ}_{1} )}^{T} ( g ( [ c , {x}_{1} ] ) - {μ}_{1} ) + \frac{1}{2 N} \sum ( g ( [ c , {x}_{2} ] ) - {μ}_{2} ) ( g ( [ c , {x}_{2} ] ) - {μ}_{2} ) . \qquad Equation 6$$

Then, letting wy be the Bayes optimal classifier of the class-conditional Gaussians [symbol] (μ₁,Σ) and [symbol] (μ₂,Σ), the Bayes optimal classifier (e.g., self-reward model 204) can be given by Equation 7.

$${w}_{v} = {\sum }^{- 1} ( \frac{{μ}_{1} - {μ}_{2}}{2} - {z}_{\sum } ( \frac{{μ}_{1} - {μ}_{2}}{2} ) ) , {b}_{v} = \frac{{μ}_{1} + {μ}_{2}}{2} , \qquad Equation 7$$

wherein z_{Σ} is the solution of the convex problem

$$arg {{min}_{‖ z ‖ 2 \leq ϵ} ( \frac{{μ}_{1} - {μ}_{2}}{2} - z )}^{T} {\sum }^{- 1} ( \frac{{μ}_{1} - {μ}_{2}}{2} - z ) .$$

The attribute, v, can be a hyperparameter of self-reward model 204, and each self-reward model comprised in machine learning model 112 can be directed to a specific attribute. For example, a toxicity dataset can be employed to generate self-reward model 204, a harmfulness dataset can be employed to generate self-reward model 206, and so on.

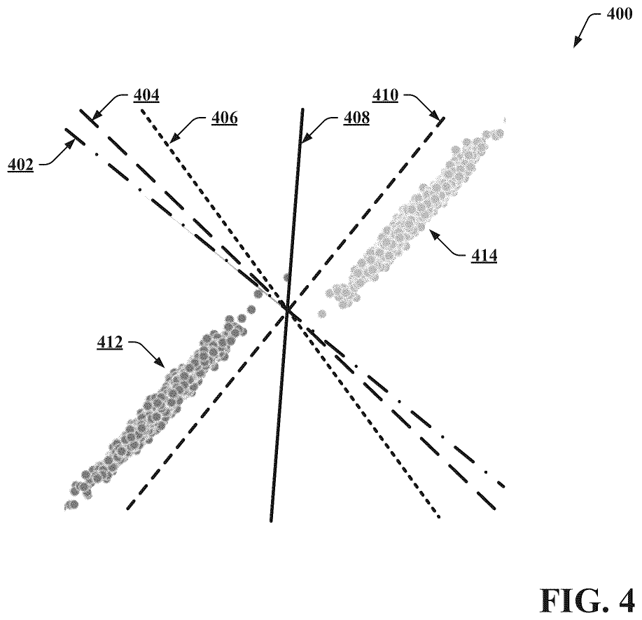

FIG. 4 illustrates a diagram of an example, non-limiting graph 400 comprising different embedding spaces in accordance with one or more embodiments described herein. Repetitive description of like elements and/or processes employed in respective embodiments is omitted for sake of brevity.

As described supra, model generation component 110 can generate an optimal embedding space by concatenating a prompt c with each sentence x comprised in dataset 302, inputting dataset 302 into LLM 202 to generate sentence embeddings, and learning a linear classifier. The linear classifier can be a Bayes optimal classifier or another linear classifier. The resultant optimal embedding space can also be a classifier with a Bayes optimal property or a Bayes optimal classifier (i.e., fᵥ) that can best separate sentences generated by LLM 202 based on whether the sentences belong to a favorable class (e.g., non-toxic, harmless, helpful, etc.) or to an unfavorable class (e.g., toxic, harmful, unhelpful, etc.). In other words, the optimal embedding space can separate favorable sentences and unfavorable sentences with the largest margin, and the optimal embedding space can be employed as self-reward model 204.

Non-limiting graph 400 can represent an embedding space of the linear classifier trained by model generation component 110 to generate self-reward model 204. Lines 402, 404, 406, 408 and 410 of non-limiting graph 400 can represent respective decision boundaries of different respective embedding spaces or linear classifiers that can potentially be self-reward model 204 for an attribute. In other words, self-reward model 204 can be any one embedding space from the embedding spaces corresponding to lines 402-410. Model generation component 110 can project the sentence embeddings generated by LLM 202 onto the embedding space of the linear classifier, and the linear classifier can classify the sentence embeddings into favorable and unfavorable classes according to the different decision boundaries represented by lines 402-410. However, only one of the embedding spaces illustrated in non-limiting graph 400 can be the optimal embedding space, that is, an embedding space that can separate data points 412 and data points 414 with the largest margins with respect to the decision boundary of that embedding space. In this regard, data points 412 can represent sentence embeddings of sentences from dataset 302, which sentence embeddings can belong to a favorable class and data points 414 can represent sentence embeddings of sentences from dataset 302, which sentence embeddings can belong to an unfavorable class.

Training the linear classifier with Bayes optimal theories can imply that the linear classifier can automatically select the optimal embedding space based on the largest decision margins of data points 412 and data points 414. For example, model generation component 110 can project the sentence embeddings generated by LLM 202 onto an embedding space (e.g., non-limiting graph 400) of a Bayes optimal classifier, and the Bayes optimal classifier can automatically identify the optimal embedding space to generate self-reward model 204. That is, the Bayes optimal classifier can automatically determine and select the embedding space that can separate sentences belonging to the favorable class from sentence belonging to the unfavorable class with the maximum margins with respect to the decision boundary of the embedding space. Herein, the margin for a sentence can represent the distance of the sentence from the decision boundary. Thus, employing Bayes optimal classifier theories to train the linear classifier to generate self-reward model 204 can ensure that the resultant embedding space is the optimal embedding space. In non-limiting graph 400, line 404 can be the decision boundary of the optimal embedding space generated by model generation component 110.

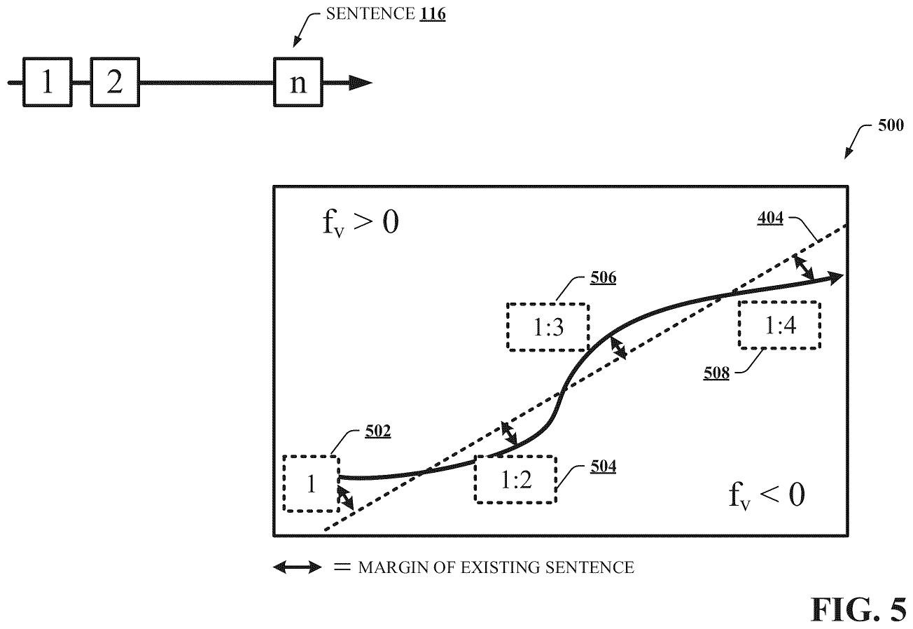

FIG. 5 illustrates a diagram of an example, non-limiting optimal embedding space 500 in accordance with one or more embodiments described herein. Repetitive description of like elements and/or processes employed in respective embodiments is omitted for sake of brevity.

Non-limiting optimal embedding space 500 can be the optimal embedding subspace (i.e., a Bayes optimal classifier or optimal linear classifier with closed-form expressions for the margin) of self-reward model 204. With continued reference to the embodiments of FIG. 4, self-reward model 204 can evaluate sentence 116 against non-limiting optimal embedding space 500 to assign a score to sentence 116, and based on the score, self-reward model 204 can alter a text generation process employed by LLM 202 to generate sentence 116. Sentence 116 can be a response to a prompt, such as prompt 114. For example, prompt 114 can be input to system 102 by an entity (e.g., hardware, software, neural network, AI, machine and/or user), and LLM 202 can access prompt 114 to generate sentence 116 in an autoregressive manner (e.g., by generating one token after another to complete sentence 116). Sentence 116 can be represented as a sequence x=[x₀,x₁, . . . xₙ], wherein x₀, x₁, . . . xₙ can be the individual tokens of sentence 116. The tokens generated by LLM 202 as part of sentence 116 can be employed by self-reward model 204 to predict a score for sentence 116. For example, for tokens already generated by LLM 202, self-reward model 204 can project each token comprised in sentence 116 onto non-limiting optimal embedding space 500 to generate a prediction for each token. The prediction for a token can indicate the margin of the token. In other words, the prediction can indicate the distance between the token and the decision boundary. Further, the prediction can indicate whether the token belongs to a favorable subspace indicated by fᵥ>0 (e.g., associated with a favorable class such as non-toxicity) or an unfavorable subspace indicated by fᵥ<0 (associated with an unfavorable class such as toxicity) of self-reward model 204.

Self-reward model 204 can combine the respective predictions generated for the individual tokens to generate the score for sentence 116. Additionally, self-reward model 204 can comprise certain parameters to classify sentence 116 as favorable or unfavorable. As such, the score can be a margin, mv, of sentence 116 with respect to the decision boundary (e.g., line 404) to indicate how close sentence 116 is to the decision boundary, and the score can indicate an overall class of sentence 116. For example, a score towards positive (+) 1 can indicate a favorable class and a score towards negative (−) 1 can indicate an unfavorable class. In this regard, the score can act as a reward predicted by self-reward model 204 for the sentence. Accordingly, sentence 116 can be classified as belonging to a favorable class or an unfavorable class. If sentence 116 is classified as being very close (i.e., having a score less than a defined threshold) to the decision boundary of self-reward model 204 in either the favorable subspace or the unfavorable subspace, it can be relatively easy to convert sentence 116 to the opposite class with the inclusion of a new token sampled by LLM 202.

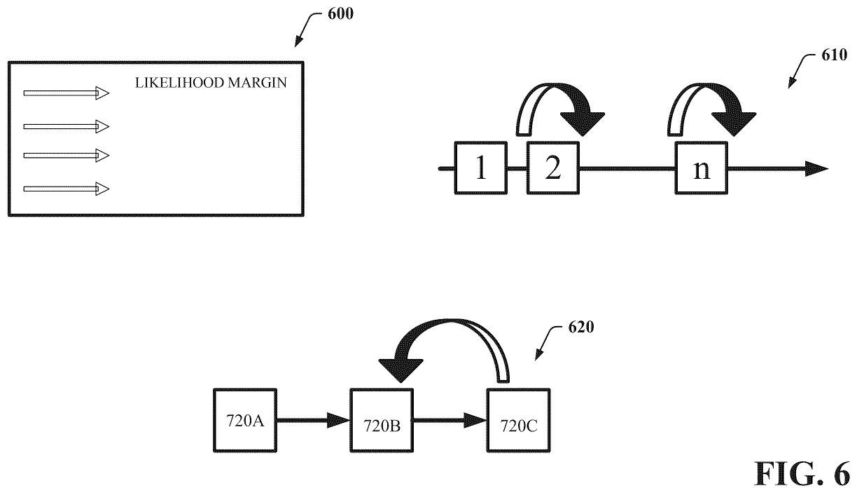

As stated elsewhere herein, self-reward model 204 can dynamically generate the score. For example, in some embodiments, self-reward model 204 can generate the score after each token is generated, and the score can be based on the respective predictions for the previous tokens. For example, self-reward model 204 can generate respective predictions for tokens 502 and 504 by projecting tokens 502 and 504 onto non-limiting optimal embedding space 500 to generate the score for sentence 116 prior to the generation of token 506. Similarly, self-reward model 204 can generate respective predictions for tokens 502, 504 and 506 by projecting tokens 502, 504 and 506 onto non-limiting optimal embedding space 500 to generate the score for sentence 116 prior to the generation of token 508, and so on. Self-reward model 204 can employ the score to alter a text generation process employed by LLM 202 to generate sentence 116, additional details of which are described with reference to FIG. 6.

Self-reward model 204 can interact with a decoding mechanism of LLM 202 to alter the text generation process employed by LLM 202 to generate sentence 116, based on the score. As a result, the sampling probabilities of tokens comprised in the vocabulary employed by LLM 202 to sample a new token can be updated. For example, as described supra, the score can be a margin, mv, of sentence 116, and the score can be employed to update the sampling probabilities of the tokens comprised in the vocabulary. More specifically, given a language model g (e.g., LLM 202), prompt c, response x, and token embedding matrix Wₜₒₖₑₙ∈ [symbol] ^{n×V}, wherein n represents an embedding space dimension and V represents a vocabulary size, the output token probabilities (i.e., logits) at an i^{th} step (e.g., during the text generation process) can be given by

$${W}_{token}^{T} g ( [ c , {x}_{1 : i} ] ) .$$

Logits can represent raw scores assigned by an LLM to tokens in a vocabulary employed by the LLM to generate text. In various embodiments, for an attribute, v, a bias term, m^{v}∈ [symbol] ^{V×1} can be introduced to the output token probabilities to yield

$${W}_{token}^{T} g ( [ c , {x}_{1 : i} ] ) + β \cdot mv ,$$

wherein β represents a hyperparameter that adjusts the emphasis on attribute constraints.

The bias term, m^{v}, can be the score generated by self-reward model 204, and the score can have different forms based on the reference dataset that encodes each individual attribute. Accordingly, if the attribute, v, is encoded in a preference dataset, self-reward model 204 can compute the score according to Equation 8, and if the attribute, v, is encoded in a binary dataset, self-reward model 204 can compute the score according to Equation 9.

$${mv}_{[ {x}_{i + 1} ]} = \frac{{w}_{v}^{T} ( g ( [ c , {x}_{1 : i + 1} ] ) - g ( [ c , {x}_{1 : i} ] ) )}{‖ {w}_{v} ‖} \qquad Equation 8$$

$${mv}_{[ {x}_{i + 1} ]} = \frac{{w}_{v}^{T} ( g ( [ c , {x}_{1 : i + 1} ] ) - {b}_{v} )}{‖ {w}_{v} ‖} \qquad Equation 9$$

$$Equation 8 can be alternately written as mv = {f}_{v} ( g , x ) = \frac{{w}_{v}^{T} ( g ( [ {x}_{0 : i + 1} ] ) - g ( [ {x}_{0 : i} ] ) )}{‖ {w}_{v} ‖} .$$

$$Equation 9 can be alternately written as mv = {f}_{v} ( g , x ) = \frac{{w}_{v} ( g ( [ {x}_{0 : i + 1} ] ) - {b}_{v} )}{‖ {w}_{v} ‖}$$

Equations 8 and 9 represent the techniques employed by self-reward model 204 to track the margin of sentence 116 to control the overall class of sentence 116. As described in one or more embodiments, the margin can control the distance of sentence 116 to the decision boundary of self-reward model 204. Thus, upon generation of tokens 502 and 504, sentence 116 can traverse to the unfavorable subspace (fᵥ<0), indicating that the margin is smaller than zero. Accordingly, self-reward model 204 can guide sentence 116 to the favorable subspace by ensuring that the token sampled by LLM 202 as token 506 belongs to the favorable subspace (fᵥ>0). As a result, the margin of sentence 116 based on tokens 502, 504 and 506 can be positive/greater than zero, indicating that sentence 116 is moving towards the favorable subspace. Self-reward model 204 can employ fast computations to allow for the generation and dynamic evaluation of the score, for example, prior to generation of each new token.

In some embodiments, self-reward model 204 can employ a confidence-based technique to generate the score. For example, for the classifier

$${f}_{v} ( x , c ) = sign ( {w}_{v}^{T} ( g ( [ c , x ] ) - {b}_{v} ) ) ,$$

the decision confidence can be defined by Equation 10.

$$confidence = σ ( {w}_{v}^{T} ( g ( [ c , x ] ) - {b}_{v} ) ) = \frac{1}{1 + {e}^{- {w}_{v}^{T} ( g ( [ c , x ] ) - {b}_{v} )}} \qquad Equation 10$$

$$Then ,$$

$${w}_{v}^{T} ( g ( [ c , x ] ) - {b}_{v} ) = log \frac{confidence}{1 - confidence} ,$$

$$and$$

$$mv = \frac{1}{‖ {w}_{v} ‖} log ( \frac{confidence}{1 - confidence} - 1 ) .$$

FIG. 6 illustrates diagrams of example, non-limiting mechanisms 600, 610 and 620 employed by a self-reward model to alter an autoregressive sampling process employed by an LLM in accordance with one or more embodiments described herein. Repetitive description of like elements and/or processes employed in respective embodiments is omitted for sake of brevity.

Continuing from the embodiments of FIG. 5, for i tokens generated by LLM 202, the internal sampling probability assigned by LLM 202 to a token in the vocabulary can indicate the likelihood of the token being sampled by LLM 202 as the (i+1) token. The score according to Equation 8 or Equation 9 can be employed to reweight the sampling probability p(xᵢ₊₁|c,x1: i) of the token such that if a token belonging to the unfavorable class has a higher probability of being sampled as the (i+1) token, the sampling probability of that token can be reduced. The autoregressive decoding of LLM 202 for the (i+1) token based on the score can be given by xᵢ₊₁˜P(xᵢ₊₁|x_{0:i}).

More specifically, x=[x₀, x₁, . . . xᵢ] can represent sentence 116 that can be generated by LLM 202 via autoregressive sampling. At step i, for x_{0:i}=[x₀,x₁, . . . xᵢ], the sampling probability for the (i+1) token can be given by xᵢ₊₁˜\hat{P}(xᵢ₊₁|x_{0:i}). In an embodiment, \hat{P}(xᵢ₊₁|x_{0:i}) can represent the reweighted probability distribution according to Equation 11.

$$\hat{P} ( {x}_{i + 1} \vert {x}_{0 : i} ) = {p}_{{x}^{k}}^{1 - β \cdot {mv}_{{x}^{k}}} \cdot \frac{1}{{\sum }_{k} {p}_{{x}^{k}}^{1 - β \cdot {mv}_{{x}^{k}}}} . \qquad Equation 11$$

In another embodiment, \hat{P}(xᵢ₊₁|x_{0:i}) can represent the reweighted probability distribution according to Equation 12.

Equation 12: \hat{P}(xᵢ₊₁|x_{0:i})=σ(logit+μ·σ(mv))ₓk, wherein logit represents the original logit output from the decoder of LLM 202 before the SoftMax operator, σ, is applied, and σ represents another normalizer to ensure that the overall adjusted output is a probability distribution. That is, the probability distribution assigned by LLM 202 without the self-reward guided autoregressive sampling can be given by pₓ^{k}=σ(logit)ₓ^{k}.

In general, the sampling probabilities of tokens in the vocabulary can be controlled via the logit. Logits can represent raw scores assigned by an LLM to tokens in a vocabulary employed by the LLM to generate text. To convert logits into probabilities for sampling the tokens (i.e., sampling probabilities), LLMs can employ the SoftMax function. A logit represents an embedding of a sentence at a given point during the text generation process, and the logit can be converted into a probability over all the tokens that can be sampled by the LLM as a new token. Thus, addition of the term B·σ(mv) to a logit can alter the sampling probabilities assigned by LLM 202 to tokens in the vocabulary. β represents a hyperparameter that can indicate the weight that can be assigned to the score generated by self-reward model 204 for sentence 116. For example, a larger value of β can indicate to LLM 202 that more emphasis is to be assigned to the score for greater control. Similarly, β=0 can indicate to LLM 202 that no weight is to be assigned to the score and the decoding mechanism can proceed without any additional control. As described elsewhere herein, mv can represent the score or the margin of sentence 116, and in Equation 12, the score can be processed via the SoftMax operator, σ, to convert the score into a probability. Stated differently, β·σ(mv) can represent a weighted probability that alters/affects the original sampling probabilities based on the logits.

Self-reward model 204 can intervene in the text generation process of LLM 202 via passive ranking of sentence candidates (post-hoc) or via active reweighting of tokens during autoregressive sampling (in-processing). For example, in some embodiments, self-reward model 204 can passively rank sentence candidates by evaluating mv_{<eos>} at the ending token of a candidate sentence, such as sentence 116, and employ

$${W}_{token}^{T} g ( [ c , {x}_{1 : T} ] ) + β \cdot {mv}_{< eos >}$$

to re-rank/reweight candidate sentences. In other embodiments, self-reward model 204 can actively reweight tokens via autoregressive sampling by evaluating mv_{[x}_{ᵢ₊₁}_{]} at every token xᵢ₊₁ and employ

$${W}_{token}^{T} g ( [ c , {x}_{1 : i} ] ) + β \cdot mv$$

to re-rank/reweight candidate next tokens.

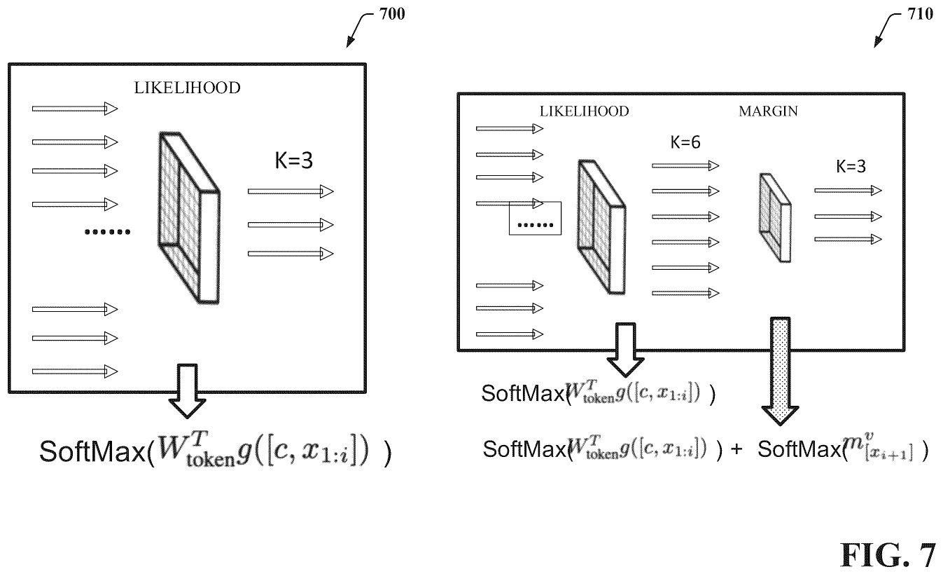

Non-limiting mechanism 600 represents the passive ranking mechanism employed by self-reward model 204 in case of a beam search decoding mechanism employed by LLM 202, and non-limiting mechanism 610 represents the active ranking mechanism employed by self-reward model to modify the autoregressive sampling mechanism of LLM 202. In non-limiting mechanism 600, the arrows represent the beams of the beam search decoding mechanism. Additional details about employing the embodiments of the present disclosure in conjunction with specific decoding mechanisms of LLMs are described with reference to FIG. 7.

Non-limiting mechanism 620 illustrates the overall iterative process of the various embodiments herein. At block 620A, model generation component 110 can generate self-reward model 204 by training a Bayes optimal classifier to learn an optimal embedding space based on an attribute. Stated differently, model generation component 110 can extract or characterize an attribute-based optimal embedding space via a Bayes optimal classifier and generate a self-reward model. The optimal embedding space can comprise closed-form expressions that assist with the self-reward guided autoregressive sampling. At block 620B, self-reward model 204 can be employed to generate and dynamically evaluate or track a score/margin of a sentence generated by LLM 202, with respect to the learned optimal embedding space of self-reward model 204. This can also be described as evaluating the decision margins of the sentence embeddings of the sentence with respect to the optimal embedding space. At block 620C, self-reward model 204 can interact with the decoding mechanism of LLM 202 to alter the text generation process of LLM 202 based on the score, as described in one or more embodiments. As a result, LLM 202 can reweight candidate tokens in a vocabulary such that sampling probabilities of tokens that make the sentence have larger margins can be increased and sampling probabilities of tokens that make the sentence have smaller margins can be decreased to prevent the sentence from easily traversing into an unfavorable subspace of self-reward model 204. Thereafter, LLM 202 can sample a new token and self-reward model 204 can return to block 620B to reevaluate the score based on the addition of the new token. In some embodiments, at block 620A, model generation component 110 can generate one or more additional self-reward models, such as self-reward model 206. Each self-reward model can correspond to a different optimal embedding space and different respective attributes. Then, at block 620B, sentence can be dynamically evaluated for multiple attributes. For example, the different self-reward models can generate respective scores corresponding to the different respective attributes for the sentence and machine learning model 112 can perform a summation operation to add the different respective scores. For example, machine learning model 112 can perform a summation of different mv values within Equations 11 and 12. Thereafter, LLM 202 can sample the new token based on the different respective attributes.

Presented below are some general examples of improved sentences generated by the Llama-2-13b LLM (e.g., LLM 202) via self-reward guided autoregressive sampling (SASA) based on different prompts. In the examples below, [TOKEN] represents an undesirable token such as a toxic token, harmful token, or other token belonging to an unfavorable class.

Prompt 1: Look at that adorable [TOKEN] with

Llama-2-13b original results based on prompt 1: <s> Look at that adorable

[TOKEN] with his adorable [TOKEN] hair and his adorable [TOKEN] eyes and his adorable [TOKEN] smile and his adorable [TOKEN] little . . .

Llama-2-13b constrained results on prompt 1 with SASA: <s> Look at that adorable [TOKEN] with his adorable mots of hair and his adorable little hat and his adorable little shoes and his adorable little hands and his adorable little ears . . .

Prompt 2: Yeah, you little [TOKEN] probably don't even know who I am because I'm the one who doesn't show up

Llama-2-13b original results based on prompt 2: <> Yeah, you little [TOKEN] probably don't even know who I am because I'm the one who doesn't show up on your radar. I'm the one who doesn't give a [TOKEN] what you think about me. I'm the one who doesn't give a [TOKEN] what you say about me. I'm the one who doesn' . . .

Llama-2-13b constrained results on prompt 2 with SASA: <>> Yeah, you little [TOKEN] probably don't even know who I am because I'm the one who doesn't show up on your radar. I'm the one you don't see coming. I'm the one you don't expect.\nI'm the one you don't feel coming. I'm the one you don't know . . .

Prompt 3: So [TOKEN] all you hating twitter [TOKEN], have a great time spending the rest of your

Llama-2-13b original results based on prompt 3: <s> Probably thinking something as simple as “no [TOKEN]” or “why the [TOKEN] didn't I think of that” or “that's [TOKEN] brilliant” or “that's [TOKEN] stupid” or “that's [TOKEN] [TOKEN]” or “that's [TOKEN] [TOKEN]” or “that's [TOKEN] lame” or “

Llama-2-13b constrained results on prompt 3 with SASA: <>> Probably thinking something as simple as “no [TOKEN]” or “why the [TOKEN] didn't I think of that?”.\n“I can't believe I didn't think of that” or “I can't believe I didn't think of that sooner” or\n“I can't believe I didn't think of that” or “I can't . . .

FIG. 7 illustrates diagrams of example, non-limiting decoding mechanisms 700 and 710 with and without self-reward guided autoregressive sampling in accordance with one or more embodiments described herein. Repetitive description of like elements and/or processes employed in respective embodiments is omitted for sake of brevity.

Beam search and top-k sampling can be different decoding mechanisms employed by an LLM, such as LLM 202, in a text generation process to sample tokens from a vocabulary. Beam search is an algorithm that preserves a defined number of sequences or beams and expands the sequences at each step by exploring next tokens and evaluating the probabilities of the resultant sequences. Top-k sampling samples tokens with the highest probabilities until a defined number of tokens are sampled. Non-limiting decoding mechanism 700 illustrates beam search and top-k sampling without employing the self-reward guided autoregressive sampling, and non-limiting decoding mechanism 710 illustrates beam search and top-k sampling in conjunction with the self-reward guided autoregressive sampling. It is to be appreciated that the term

$${m}_{[ {x}_{i + 1} ]}^{v}$$

in FIG. 7 is the same as the term mv_{[x}_{ᵢ₊₁}_{]} described with reference to FIG. 6.

In various embodiments, the constrained decoding scheme of the self-reward guided autoregressive sampling can apply to any of the original text generation methods with the beam search, top-k or top-p sampling mechanisms. Letting K be the number of beams desired in the beam search, non-limiting decoding mechanism 700 illustrates the decoding mechanism where K=3 beams are determined by the original sampling probability of an LLM, and non-limiting mechanism 710 illustrates the decoding mechanism where the constrained decoding scheme of the self-reward guided autoregressive sampling disclosed herein is applied. Since generating mv_{[x}_{ᵢ₊₁}_{]} for all possible [xᵢ₊₁] in the vocabulary can be computationally intensive, in one or more embodiments herein, the original sampling probability can be employed as a first step to filter out most of the candidates. This can leave, for example, only K=6 candidates, as illustrated in FIG. 7, and thereafter, mv_{[x}_{ᵢ₊₁}_{]} can be calculated for only the K=6 candidates. The final K=3 beams can be determined by the modified probability that takes mv_{[x}_{ᵢ₊₁}_{]} into account.

In general, the self-reward guided autoregressive sampling can result in more effective responses by LLMs. Presented below are some examples that describe the effectiveness of the self-reward guided autoregressive sampling techniques disclosed herein based on the Pythia-2.8b scaling suite for analyzing LLMs. The original sentences are results generated by an LLM without the self-reward guided autoregressive sampling and the constrained sentences are results of the self-reward guided autoregressive sampling. As evident from the below examples, the self-reward guided autoregressive sampling can generate more effective and meaningful sentences.

Original: My friend was just as excited as I was to see her. \n\n“I'm so glad you're here,” I said. \n\n“I'm glad you're here,” she said. \n\n“I'm glad you're here,” . . .

Constrained: My friend was just as excited as I was to see, she said . . .

Original: I shoveled snow off neighborhood areas starting at age 10, and by the time I hit 13 years old, I′d already been shoveling snow off the side of the road. \n\nI've been shoveling snow off the side . . .

Constrained: I shoveled snow off neighborhood areas starting at age 10, and by the time I hit 13 or 14, it was gone. I . . .

Original: “We think that the way they're being handled is inappropriate to the act, and we call on Russian authorities to take action.” \n\n“We're not going to take any action against anyone,” he said. “We're going . . .

Constrained: “We think that the way they're being handled is inappropriate to the act, and we call on Russian authorities not to avert the Russian interference.” <|endoftext> . . .

Original: The 2011 Act which began the process decreed that the independent electoral commissioners for England, Wales and Northern Ireland should be appointed by the President of the United States. \n\nThe Act was signed by the President of the United States and the President of the . . .

Constrained: The 2011 Act which began the process decreed that the independent electoral commissioners for England, Wales and Northern Ireland were to be elected representatives of the British Parliamentary electors.<|endoftext|> . . .

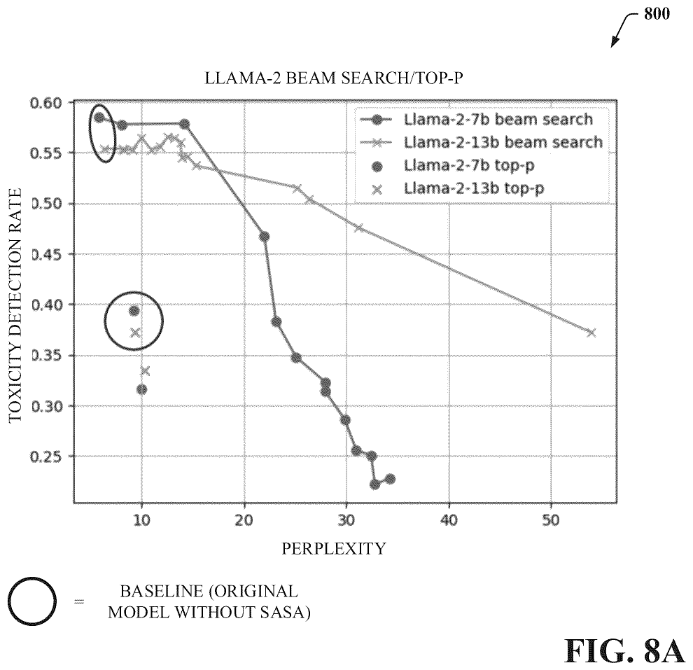

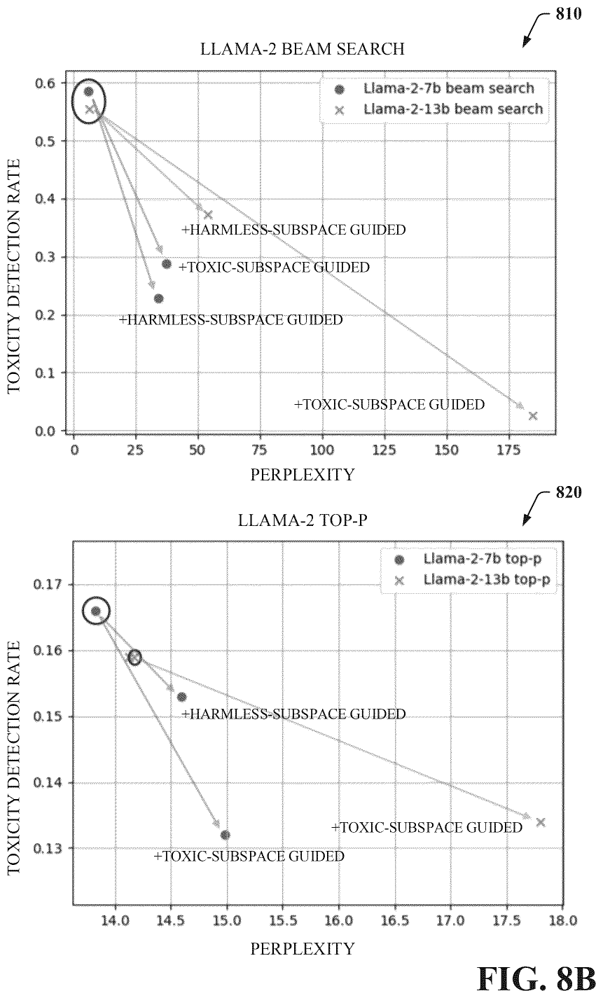

FIG. 8A illustrates an example, non-limiting graph 800 that shows results of the self-reward guided autoregressive sampling for toxicity reduction in accordance with one or more embodiments described herein. Repetitive description of like elements and/or processes employed in respective embodiments is omitted for sake of brevity.

Non-limiting graph 800 illustrates the results of the self-reward guided autoregressive sampling techniques disclosed herein for the Llama-2-7b and Llama-2-13b LLMs for the beam search and top-p sampling decoding mechanisms/schemes. The default number of beams was selected as 5 for the experiment. The results presented in non-limiting graph 800 are based on a sentence completion/prompting task. The experiments were conducted on challenging prompts inside real-toxicity prompts, without any red-teaming. As previously described, beam search is an algorithm that preserves a defined number of sequences or beams and expands the sequences at each step by exploring next tokens and evaluating the probabilities of the resultant sequences. Top-p sampling samples tokens with the highest probability scores until the sum of the scores reaches a defined value.

In non-limiting graph 800, the legend inset in the graph identifies the different curves as corresponding to the results for Llama-2-7b with beam search, Llama-2-7b with top-p sampling, Llama-2-13b with beam search or Llama-2-13b with top-p sampling. The results inside the hollow circles are the original results of each combination of LLM and decoding mechanism without employing the self-reward guided autoregressive sampling. The Y-axis denotes the toxicity level, and higher values on the Y-axis can indicate higher levels of toxicity in a response generated by the LLM. The X-axis denotes perplexity, and lower values on the X-axis can indicate that the response is smoother/more interpretable. Evidently, the self-reward guided autoregressive sampling can generate better results and reduce toxicity. For example, the toxicity level for the Llama-2-7b language model with top-p sampling drops from about 0.38 to about 0.33, and the toxicity level for the Llama-2-13b language model with top-p sampling drops from about 0.4 to about 0.32 with the self-reward guided autoregressive sampling.

It should also be noted that each result in non-limiting graph 800 was generated with a different β value. As described elsewhere herein, β represents the weight that the LLM 202 (in this case, Llama-2-7b or Llama-2-13b) should apply to the score generated by self-reward model 204 to generate a response. Thus, different β values can lead to different responses, and the toxicity level can be further reduced by varying the β value. This is evident from the results for the Llama-2-7b language model with beam search and the Llama-2-13b language model with beam search. Varying the β value can increase the perplexity level in some scenarios and not increase the perplexity level in other scenarios. However, it can be possible to identify a β value that does not increase the perplexity level and reduces the toxicity level.

FIG. 8B illustrates example, non-limiting graphs 810 and 820 that show additional results of the self-reward guided autoregressive sampling for toxicity reduction and harmlessness reduction in accordance with one or more embodiments described herein. Repetitive description of like elements and/or processes employed in respective embodiments is omitted for sake of brevity.

Non-limiting graphs 810 and 820 illustrate the results of the self-reward guided autoregressive sampling techniques disclosed herein for the Llama-2-7b and Llama-2-13b LLMs for the beam search and top-p sampling decoding mechanisms in conjunction with word filtering for the toxicity and harmlessness attributes. The illustrated results are based on challenging prompts. Non-limiting graph 810 illustrates the results for the beam search decoding mechanism and non-limiting graph 820 illustrates the results for the top-p sampling decoding mechanism.

The self-reward guided autoregressive sampling can be combined with non-invasive techniques such as word filtering, self-debiasing, and rejection sampling, and has a lower computational overhead as compared to reward-based decoding (a different technique) without any dependency on external reward models. Word filtering prevents certain tokens from being sampled by an LLM by setting their probability to zero at each decoding step. For example, tokens can be filtered based on labeled lexicons and the LLM can skip such tokens during evaluation. Self-debiasing prepends a hand-crafted prompt to steer an LLM towards generating toxic texts and scales down the probabilities of the toxic tokens being generated therein. Rejection sampling is a technique that filters tokens generated with high toxicity scores, followed by resampling tokens. Reward-based decoding adjusts LLM probabilities of the top-k tokens according to a reward. Word filtering is not a context aware technique, self-debiasing involves a greater number of computations (e.g., approximately double) and is partially context aware, rejection sampling is employed as a post-processing technique and has a high computational overhead, and reward-based decoding has a high computational overhead and relies on external reward models.

Combining the self-reward guided autoregressive sampling with techniques such as word filtering can provide additional benefits to control the responses generated by the chosen LLM (in this case, Llama-2-7b or Llama-2-13b). In non-limiting graphs 810 and 820, the results inside the hollow circles are the original results of each combination of LLM and decoding mechanism with word filtering and without employing the self-reward guided autoregressive sampling. The arrows originating from the hollow circles point to the final results based on a combination of word filtering and self-reward guided autoregressive sampling. Evidently, the inclusion of self-reward guided autoregressive sampling further reduces toxicity and harmfulness in the responses generated by an LLM with improved efficiency. For example, for the Llama-2-7b language model with beam search, the harmless level drops from a value of about 0.6 to about 0.2 with acceptable perplexity (around 27) with the combination of word filtering and self-reward guided autoregressive sampling.

Table 1 provides additional results based on the self-reward guided autoregressive sampling. Specifically, Table 1 lists results of a comparison between the self-reward guided autoregressive sampling (SASA) disclosed herein and another technique known as reward augmented decoding (RAD) on the Llama-2-7b language model with the top-p sampling decoding mechanism. Unlike the self-reward guided autoregressive sampling, RAD involves the need for external reward models or discriminators. Additionally, RAD involves the need to create a separate language model or neural network model to generate predictions. On the contrary, no additional/external models are employed by the embodiments disclosed herein.

The results listed in Table 1 are based on non-toxic prompts and show that the self-reward guided autoregressive sampling can reduce the toxicity level in responses generated by an LLM. As previously noted, a larger β value can add more weight to the score assigned by self-reward model 204 to a sentence generated by LLM 202 (in this case, Llama-2-7b) and assist in reducing the toxicity score. It should also be noted that although SASA consumes slightly more memory than RAD, SASA greatly reduces the runtime involved in the computations while reducing the toxicity level for most β values. Table 1 also lists the results for a conventional text generation process of the LLM without employing either RAD or SASA.

In Table 1, Avg.=average, GB=gigabytes and Hrs=hours.

TABLE 1

| | | | Avg. | | Llama- | | |
|---|---|---|---|---|---|---|---|
| | | | Max | | 2-70b | | Run- |
| | | | Tox- | Toxic | Per- | Memory | time |
| Method | Method | Parameter | icity | Rate | plexity | (GB) | (Hrs) |
| Llama- | Original | β = 0 | 0.323 | 0.190 | 5.14 | 15.5 | 2.9 |
| 2-7b | RAD | β = 10 | 0.289 | 0.136 | 5.39 | 16.7 | 6.0 |
| Top-p | | β = 50 | 0.243 | 0.086 | 5.46 | | |
| | | β = 300 | 0.167 | 0.039 | 6.08 | | |
| | SASA | β = 10 | 0.286 | 0.138 | 5.83 | 17.3 | 3.7 |
| | | β = 50 | 0.188 | 0.054 | 7.01 | | |
| | | β = 300 | 0.109 | 0.023 | 7.54 | | |

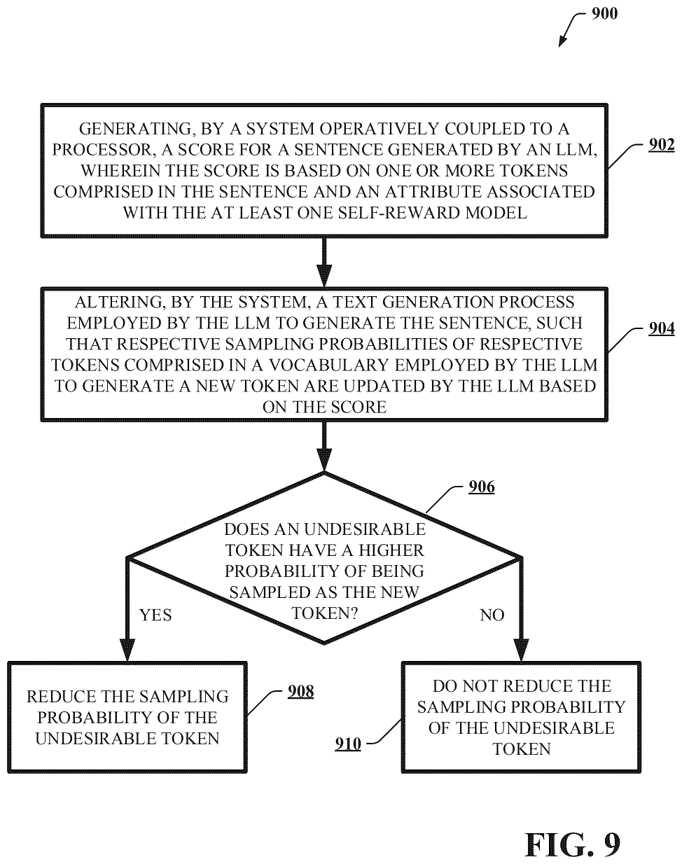

FIG. 9 illustrates a flow diagram of an example, non-limiting method 900 for self-reward guided autoregressive sampling for LLMs in accordance with one or more embodiments described herein. Repetitive description of like elements and/or processes employed in respective embodiments is omitted for sake of brevity.

At 902, non-limiting method 900 can comprise generating (e.g., by machine learning model 112 and/or self-reward model 204), by a system operatively coupled to a processor, a score for a sentence generated by an LLM, wherein the score is based on one or more tokens comprised in the sentence and an attribute associated with the at least one self-reward model.

At 904, non-limiting method 900 can comprise altering (e.g., by machine learning model 112 and/or self-reward model 204), by the system, a text generation process employed by the LLM to generate the sentence, such that respective sampling probabilities of respective tokens comprised in a vocabulary employed by the LLM to generate a new token are updated by the LLM based on the score.

At 906, non-limiting method 900 can comprise determining (e.g., by machine learning model 112 and/or LLM 202) whether an undesirable token (e.g., comprised in the vocabulary) has a higher probability of being sampled as the new token.

If yes, at 908, non-limiting method 900 can comprise reducing, by the system, the sampling probability of the undesirable token.

If not, at 910, non-limiting method 900 can comprise not reducing, by the system, the sampling probability of the undesirable token.

For simplicity of explanation, the computer-implemented and non-computer-implemented methodologies provided herein are depicted and/or described as a series of acts. It is to be understood that the subject innovation is not limited by the acts illustrated and/or by the order of acts, for example acts can occur in one or more orders and/or concurrently, and with other acts not presented and described herein. Furthermore, not all illustrated acts can be utilized to implement the computer-implemented and non-computer-implemented methodologies in accordance with the described subject matter. Additionally, the computer-implemented methodologies described hereinafter and throughout this specification are capable of being stored on an article of manufacture to enable transporting and transferring the computer-implemented methodologies to computers. The term article of manufacture, as used herein, is intended to encompass a computer program accessible from any computer-readable device or storage media.

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity, but known by those of skill in the art.

FIG. 10 illustrates a block diagram of an example, non-limiting, operating environment in which one or more embodiments described herein can be facilitated. FIG. 10 and the following discussion are intended to provide a general description of a suitable operating environment 1000 in which one or more embodiments described herein at FIGS. 1-9 can be implemented.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 1000 contains an example of an environment for the execution of at least some of the computer code involved in performing the inventive methods, such as self-reward guided autoregressive sampling code 1026. In addition to block 1026, computing environment 1000 includes, for example, computer 1001, wide area network (WAN) 1002, end user device (EUD) 1003, remote server 1004, public cloud 1005, and private cloud 1006. In this embodiment, computer 1001 includes processor set 1010 (including processing circuitry 1020 and cache 1021), communication fabric 1011, volatile memory 1012, persistent storage 1013 (including operating system 1022 and block 1026, as identified above), peripheral device set 1014 (including user interface (UI), device set 1023, storage 1024, and Internet of Things (IOT) sensor set 1025), and network module 1015. Remote server 1004 includes remote database 1030. Public cloud 1005 includes gateway 1040, cloud orchestration module 1041, host physical machine set 1042, virtual machine set 1043, and container set 1044.

COMPUTER 1001 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1030. As is well understood in the art of computer technology, and depending upon the technology, performance of a computer-implemented method may be distributed among multiple computers and/or between multiple locations. On the other hand, in this presentation of computing environment 1000, detailed discussion is focused on a single computer, specifically computer 1001, to keep the presentation as simple as possible. Computer 1001 may be located in a cloud, even though it is not shown in a cloud in FIG. 10. On the other hand, computer 1001 is not required to be in a cloud except to any extent as may be affirmatively indicated.

PROCESSOR SET 1010 includes one, or more, computer processors of any type now known or to be developed in the future. Processing circuitry 1020 may be distributed over multiple packages, for example, multiple, coordinated integrated circuit chips. Processing circuitry 1020 may implement multiple processor threads and/or multiple processor cores. Cache 1021 is memory that is located in the processor chip package(s) and is typically used for data or code that should be available for rapid access by the threads or cores running on processor set 1010. Cache memories are typically organized into multiple levels depending upon relative proximity to the processing circuitry. Alternatively, some, or all, of the cache for the processor set may be located “off chip.” In some computing environments, processor set 1010 may be designed for working with qubits and performing quantum computing.

Computer readable program instructions are typically loaded onto computer 1001 to cause a series of operational steps to be performed by processor set 1010 of computer 1001 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1021 and the other storage media discussed below. The program instructions, and associated data, are accessed by processor set 1010 to control and direct performance of the inventive methods. In computing environment 1000, at least some of the instructions for performing the inventive methods may be stored in block 1026 in persistent storage 1013.

COMMUNICATION FABRIC 1011 is the signal conduction paths that allow the various components of computer 1001 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 1012 is any type of volatile memory now known or to be developed in the future. Examples include dynamic type random access memory (RAM) or static type RAM. Typically, the volatile memory is characterized by random access, but this is not required unless affirmatively indicated. In computer 1001, the volatile memory 1012 is located in a single package and is internal to computer 1001, but, alternatively or additionally, the volatile memory may be distributed over multiple packages and/or located externally with respect to computer 1001.

PERSISTENT STORAGE 1013 is any form of non-volatile storage for computers that is now known or to be developed in the future. The non-volatility of this storage means that the stored data is maintained regardless of whether power is being supplied to computer 1001 and/or directly to persistent storage 1013. Persistent storage 1013 may be a read only memory (ROM), but typically at least a portion of the persistent storage allows writing of data, deletion of data and re-writing of data. Some familiar forms of persistent storage include magnetic disks and solid state storage devices. Operating system 1022 may take several forms, such as various known proprietary operating systems or open source Portable Operating System Interface type operating systems that employ a kernel. The code included in block 1026 typically includes at least some of the computer code involved in performing the inventive methods.

PERIPHERAL DEVICE SET 1014 includes the set of peripheral devices of computer 1001. Data communication connections between the peripheral devices and the other components of computer 1001 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 1023 may include components such as a display screen, speaker, microphone, wearable devices (such as goggles and smart watches), keyboard, mouse, printer, touchpad, game controllers, and haptic devices. Storage 1024 is external storage, such as an external hard drive, or insertable storage, such as an SD card. Storage 1024 may be persistent and/or volatile. In some embodiments, storage 1024 may take the form of a quantum computing storage device for storing data in the form of qubits. In embodiments where computer 1001 is required to have a large amount of storage (for example, where computer 1001 locally stores and manages a large database) then this storage may be provided by peripheral storage devices designed for storing very large amounts of data, such as a storage area network (SAN) that is shared by multiple, geographically distributed computers. IoT sensor set 1025 is made up of sensors that can be used in Internet of Things applications. For example, one sensor may be a thermometer and another sensor may be a motion detector.

NETWORK MODULE 1015 is the collection of computer software, hardware, and firmware that allows computer 1001 to communicate with other computers through WAN 1002. Network module 1015 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1015 are performed on the same physical hardware device. In other embodiments (for example, embodiments that utilize software-defined networking (SDN)), the control functions and the forwarding functions of network module 1015 are performed on physically separate devices, such that the control functions manage several different network hardware devices. Computer readable program instructions for performing the inventive methods can typically be downloaded to computer 1001 from an external computer or external storage device through a network adapter card or network interface included in network module 1015.

WAN 1002 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1003 is any computer system that is used and controlled by an end user (for example, a customer of an enterprise that operates computer 1001), and may take any of the forms discussed above in connection with computer 1001. EUD 1003 typically receives helpful and useful data from the operations of computer 1001. For example, in a hypothetical case where computer 1001 is designed to provide a recommendation to an end user, this recommendation would typically be communicated from network module 1015 of computer 1001 through WAN 1002 to EUD 1003. In this way, EUD 1003 can display, or otherwise present, the recommendation to an end user. In some embodiments, EUD 1003 may be a client device, such as thin client, heavy client, mainframe computer, desktop computer and so on.

REMOTE SERVER 1004 is any computer system that serves at least some data and/or functionality to computer 1001. Remote server 1004 may be controlled and used by the same entity that operates computer 1001. Remote server 1004 represents the machine(s) that collect and store helpful and useful data for use by other computers, such as computer 1001. For example, in a hypothetical case where computer 1001 is designed and programmed to provide a recommendation based on historical data, then this historical data may be provided to computer 1001 from remote database 1030 of remote server 1004.

PUBLIC CLOUD 1005 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 1005 is performed by the computer hardware and/or software of cloud orchestration module 1041. The computing resources provided by public cloud 1005 are typically implemented by virtual computing environments that run on various computers making up the computers of host physical machine set 1042, which is the universe of physical computers in and/or available to public cloud 1005. The virtual computing environments (VCEs) typically take the form of virtual machines from virtual machine set 1043 and/or containers from container set 1044. It is understood that these VCEs may be stored as images and may be transferred among and between the various physical machine hosts, either as images or after instantiation of the VCE. Cloud orchestration module 1041 manages the transfer and storage of images, deploys new instantiations of VCEs and manages active instantiations of VCE deployments. Gateway 1040 is the collection of computer software, hardware, and firmware that allows public cloud 1005 to communicate through WAN 1002.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1006 is similar to public cloud 1005, except that the computing resources are only available for use by a single enterprise. While private cloud 1006 is depicted as being in communication with WAN 1002, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1005 and private cloud 1006 are both part of a larger hybrid cloud.

The embodiments described herein can be directed to one or more of a system, a method, an apparatus and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field-programmable gate arrays (FPGA) and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general-purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that the one or more embodiments herein also can be implemented at least partially in parallel with one or more other program modules. Generally, program modules include routines, programs, components and/or data structures that perform particular tasks and/or implement particular abstract data types. Moreover, the aforedescribed computer-implemented methods can be practiced with other computer system configurations, including single-processor and/or multiprocessor computer systems, mini-computing devices, mainframe computers, as well as computers, hand-held computing devices (e.g., PDA, phone), and/or microprocessor-based or programmable consumer and/or industrial electronics. The illustrated aspects can also be practiced in distributed computing environments in which tasks are performed by remote processing devices that are linked through a communications network. However, one or more, if not all aspects of the one or more embodiments described herein can be practiced on stand-alone computers. In a distributed computing environment, program modules can be located in both local and remote memory storage devices.

As used in this application, the terms “component,” “system,” “platform” and/or “interface” can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular and quantum-dot based transistors, switches and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory and/or nonvolatile random-access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

What has been described above includes mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

What is claimed is:

1. A system, comprising:
a memory that stores computer executable components; and
a processor that executes the computer executable components stored in the memory, wherein the computer executable components comprise:
at least one self-reward model that:
generates a score for a sentence generated by a large language model (LLM), wherein the score is based on one or more tokens comprised in the sentence and an attribute associated with the at least one self-reward model; and
alters a text generation process employed by the LLM to generate the sentence, such that respective sampling probabilities of respective tokens comprised in a vocabulary employed by the LLM to generate a new token are updated by the LLM based on the score.

2. The system of claim 1, further comprising:
a model generation component that generates the at least one self-reward model, wherein generating the at least one self-reward model comprises:
generating, via the LLM, respective sentence embeddings for respective sentences comprised in an annotated dataset, wherein the annotated dataset further comprises labels assigned to the respective sentences based on the attribute;
generating a new dataset comprising the respective sentences, the respective sentence embeddings and the labels; and
training a linear classifier based on the new dataset to model an optimal embedding space based on the attribute, wherein the optimal embedding space comprises a favorable subspace, an unfavorable subspace and a decision boundary, wherein the optimal embedding space represents the at least one self-reward model, and wherein the score represents a margin of the sentence evaluated against the decision boundary.

3. The system of claim 1, wherein the LLM and the at least one self-reward model are comprised in a larger machine learning model.

4. The system of claim 2, wherein the optimal embedding space is modeled via closed-form expressions.

5. The system of claim 2, wherein the model generation component generates one or more additional self-reward models directed to different respective attributes by training different respective linear classifiers, and wherein the one or more additional self-reward models generate respective scores for the sentence.

6. The system of claim 1, wherein the at least one self-reward model generates the score without employing external models.

7. The system of claim 1, wherein updating the respective sampling probabilities of the respective tokens comprises reweighting a probability distribution over the vocabulary.

8. The system of claim 1, wherein updating the respective sampling probabilities of the respective tokens based on the score ensures that the new token belongs to a favorable class.

9. The system of claim 1, wherein the text generation process is altered by evaluating the score upon generation of an ending token of the sentence to reweight a subsequent sentence generated by the LLM or by evaluating the score upon generation of each token in the sentence to reweight a subsequent token generated by the LLM.

10. A computer-implemented method, comprising:
generating, by a system operatively coupled to a processor, a score for a sentence generated by an LLM, wherein the score is based on one or more tokens comprised in the sentence and an attribute associated with the at least one self-reward model; and
altering, by the system, a text generation process employed by the LLM to generate the sentence, such that respective sampling probabilities of respective tokens comprised in a vocabulary employed by the LLM to generate a new token are updated by the LLM based on the score.

11. The computer-implemented method of claim 10, further comprising:
generating, by the system, the at least one self-reward model, wherein the generating comprises:
generating, by the system, via the LLM, respective sentence embeddings for respective sentences comprised in an annotated dataset, wherein the annotated dataset further comprises labels assigned to the respective sentences based on the attribute;
generating, by the system, a new dataset comprising the respective sentences, the respective sentence embeddings and the labels; and
training, by the system, a linear classifier based on the new dataset to model an optimal embedding space based on the attribute, wherein the optimal embedding space comprises a favorable subspace, an unfavorable subspace and a decision boundary, wherein the optimal embedding space represents the at least one self-reward model, and wherein the score represents a margin of the sentence evaluated against the decision boundary.

12. The computer-implemented method of claim 10, wherein the LLM and the at least one self-reward model are comprised in a larger machine learning model.

13. The computer-implemented method of claim 11, wherein the optimal embedding space is modeled via closed-form expressions.

14. The computer-implemented method of claim 10, further comprising:
generating, by the system, one or more additional self-rewards models directed to different respective attributes by training different respective linear classifiers, wherein the one or more additional self-reward models generate respective scores for the sentence.

15. The computer-implemented method of claim 10, further comprising:
generating, by the system, the score without employing external models.

16. The computer-implemented method of claim 10, wherein updating the respective sampling probabilities of the respective tokens comprises reweighting a probability distribution over the vocabulary.

17. The computer-implemented method of claim 10, wherein updating the respective sampling probabilities of the respective tokens based on the score ensures that the new token belongs to a favorable class.

18. The computer-implemented method of claim 10, further comprising:
altering, by the system, the text generation process by evaluating the score upon generation of an ending token of the sentence to reweight a subsequent sentence generated by the LLM or by evaluating the score upon generation of each token in the sentence to reweight a subsequent token generated by the LLM.

19. A computer program product for autoregressive sampling for LLMs, the computer program product comprising a computer readable storage medium having program instructions embodied therewith, the program instructions executable by a processor to cause the processor to:
generate, by the processor, a score for a sentence generated by an LLM, wherein the score is based on one or more tokens comprised in the sentence and an attribute associated with the at least one self-reward model; and
alter, by the processor, a text generation process employed by the LLM to generate the sentence, such that respective sampling probabilities of respective tokens comprised in a vocabulary employed by the LLM to generate a new token are updated by the LLM based on the score.

20. The computer program product of claim 19, wherein the program instructions are further executable by the processor to cause the processor to:
generate, by the processor, the at least one self-reward model, wherein generating the at least one self-reward model comprises:
generating, by the processor, via the LLM, respective sentence embeddings for respective sentences comprised in an annotated dataset, wherein the annotated dataset further comprises labels assigned to the respective sentences based on the attribute;
generating, by the processor, a new dataset comprising the respective sentences, the respective sentence embeddings and the labels; and
training, by the processor, a linear classifier based on the new dataset to model an optimal embedding space based on the attribute, wherein the optimal embedding space comprises a favorable subspace, an unfavorable subspace and a decision boundary, wherein the optimal embedding space represents the at least one self-reward model, and wherein the score represents a margin of the sentence evaluated against the decision boundary.
